(19) United States
(12) Patent Application Publication
(10) Pub. No.: US 2024/0312000 A1
(43) Pub. Date: Sep. 19, 2024

(54) CONTEXT BASED DEFECT DETECTION

(71) Applicant: AI QUALISENSE 2021 LTD, Tel Aviv-Yafo (IL)

(72) Inventor: Adam Zrehen, Tel Aviv-Yafo (IL)

(73) Assignee: AI QUALISENSE 2021 LTD, Tel Aviv-Yafo (IL)

(21) Appl. No.: 18/607,351

(22) Filed: Mar. 15, 2024

Related U.S. Application Data
(60) Provisional application No. 63/490,518, filed on Mar. 15, 2023.

(51) Int. Cl. G06T 7/00

(52) U.S. Cl. CPC G06T 7/001; G06T 2207/20081; G06T 2207/30108

(57) ABSTRACT

A method for context based detection of defects of manufactured items, the method may include (i) receiving an image of an evaluated manufactured item (EMI), the EMI was manufactured by a manufacturing process; (ii) generating EMI patches representations that are related to the EMI; wherein the EMI patches representations of the EMI are selected out of (a) representations of patches of the image of the EMI, or (b) patches of a representation of the image of the EMI; (iii) calculating EMI patches representations scores, wherein an EMI patch representation score of a certain EMI patch representation is determined based on similarities between the certain EMI patch representation and other EMI patch representations; and (iv) determining a defect related status of the EMI based on at least some of the EMI patches representations scores and on at least one similarity related values

### BACKGROUND OF THE INVENTION

Defect detection should not be limited to already known defects—as this will limit the defect detection capabilities of a defect detection method. Furthermore—basing the defect detection on a known library of defects may require to spend a significant amount of resources to building a defect library.

There is a need to provide a defect detection method that is not based on a library of known defects.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIG. 3 illustrates an example of a EMI and histogram of z-scores; and

FIG. 4 illustrates an example of a system.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There is provide a method for defect detection that is based on self similarities and does not require a prior knowledge of defects—as well does not require to label a training set with defects.

Defects in a production process are detected by evaluating the change in relationships between neighboring portions of an image of the process part. For example, the cosine similarity of one image patch and another image patch is the “relationship” that can change if a defect is present in one of the patches relative to when a defect is not present. The criteria for defect detection may be a change in a single relationship or a change in multiple relationships.

In the case of multiple relationships, this could imply only the local patches (e.g., neighboring 8 patches), or patches at any location in the image.

Alternatively, the relationship can imply “self-similarity” in order to reduce false alarms (if one patch is similar to another patch, then it is not a defect).

The similarity may differ from cosine similarity. For example—other similarity metrics such as Euclidean distance, dot product, and the like.

Another possible similarity calculation uses a patch-by-patch convolution—for example a dataset with n training images is first split into m equally sized patches per image. A patch-by-patch convolution is applied for each patch with all other patches. A feature vector representation is produced for each patch.

There may be provided one or more variations of context-based defect detection:
a. Self-similarity (false alarm reduction) using an absolute threshold comparing the relationship of each patch with all other patches in the image.
b. Defect detection using thresholds obtained from the training set comparing the relationship of each patch with all other patches in the image.
c. Self-similarity (false alarm reduction) using thresholds obtained from the training set comparing the relationship of each patch with 8 neighboring patches.
d. Defect detection using thresholds obtained from the training set comparing the relationship of each patch with 8 neighboring patches.
e. Self-similarity (false alarm reduction) using an absolute threshold comparing the relationship of each patch with 8 neighboring patches.
f. Defect detection using an absolute threshold comparing the relationship of each patch with 8 neighboring patches.

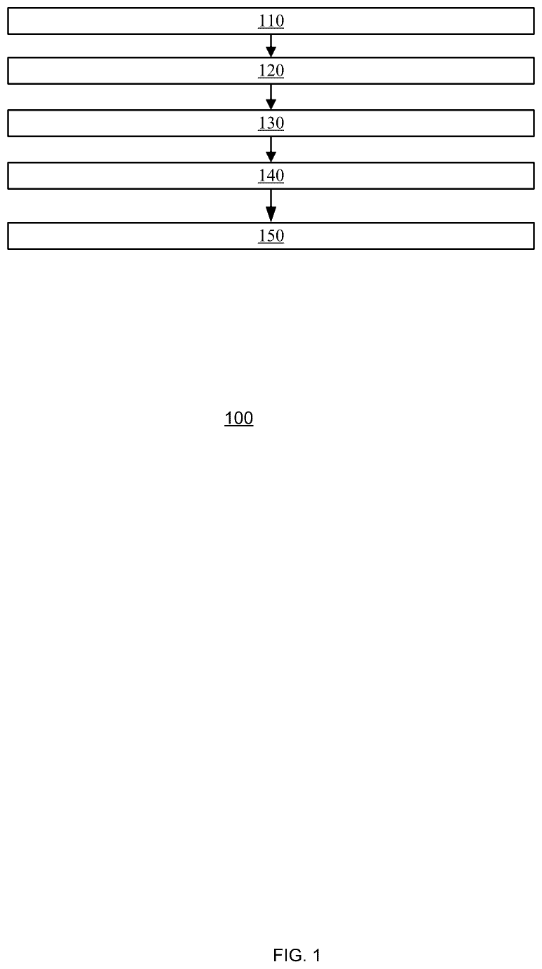

FIG. 1 illustrates a method 100 for context based detection of defects of manufactured items.

Method 100 may start by step 110 of receiving an image of an evaluated manufactured item (EMI), the EMI was manufactured by a manufacturing process.

Step 110 may be followed by step 120 of generating EMI patches representations that are related to the EMI.

EMI patches representations of the EMI are selected out of (a) representations of patches of the image of the EMI, or (b) patches of a representation of the image of the EMI.

Step 120 may be followed by step 130 of calculating EMI patches representations scores, wherein an EMI patch representation score of a certain EMI patch representation may be determined based on similarities between the certain EMI patch representation and other EMI patch representations.

The other EMI patch representations may be:
a. All EMI patch representations other than the certain EMI patch representation.
b. Only some of all EMI patch representations other than the certain EMI patch representation.
c. Only neighbors of the certain EMI patch representation. A neighbor may be located at a certain distance from the certain EMI patch representation—for example the immediate neighbors, neighbors that are spaced apart by 2, 3, or 4 EMI patch representations, and the like.

Step 130 may be followed by step 140 of determining a defect related status of the EMI based on at least some of the EMI patches representations scores and on at least one similarity related value.

The at least some of the EMI patches representations scores may be all the EMI patches representations scores.

The at least one similarity related value may:
a. Be at least one similarity threshold.
b. Be a fixed similarity threshold that is set in any manner—random, pseudo random, according to a rule, according to a desired false alarm ratio and/or a desired false positive ratio, and the like.
c. Be determined based on EMI patches representations scores learnt during a training process.
d. Be determined based on statistics of EMI patches representations scores learnt during a training process.
e. Be determined based on (a) a standard deviation of EMI patches representations scores learnt during a training process, and (b) a mean of EMI patches representations scores learnt during the training process.

Step 140 may include determining that two EMI patches representations are not indicative of a EMI defect when EMI patches representations scores of the two EMI patches representations are similar to each other.

Step 140 may be followed by step 150 of responding to the determining.

The responding of step 150 may include generating an alert about a faulty EMI, generating a acceptable EMI notice, determining how to amend the manufacturing process, automatically instructing or requesting to stop and/or alter the manufacturing process, and the like.

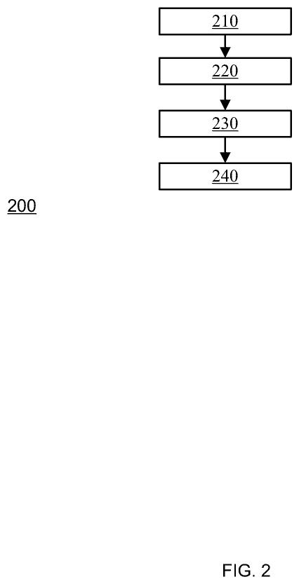

FIG. 2 illustrates method 200 for determining at least one similarity related value.

Method 200 may start by step 210 of receiving a set of training image of reference manufactured items (RMIs), the RMIs were manufactured by a manufacturing process.

Step 210 may be followed by step 220 of generating RMI patches representations that are related to the RMI.

RMI patches representations of a RMI are selected out of (a) representations of patches of the reference image of the RMI, or (b) patches of a representation of the reference image of the RMI. For example—(a) an image of the RMI may be segmented to patches and each image and then calculating a feature vector of each image path, about (b)—generating a feature map of the entire image and then segmenting the feature map, and subsequently linearizing the feature map.

Step 220 may be followed by step 230 of calculating RMI patches representations scores, wherein an RMI patch representation score of a certain RMI patch representation may be determined based on similarities between the certain RMI patch representation and other RMI patch representations related to the certain RMI patch.

Step 230 may be followed by step 240 of calculating the at least one similarity related value based on the RMI patches representations scores.

Assuming that the at least one similarity related value is a mean value (per location—for example a coordinate of a patch in an image or in an image representation) and standard deviation (per location), or at least a similarity related value based on at least the mean value (per location) and the standard deviation (per location), then step 240 may include:
a. Per each RMI patch representation related to a training image of set of training images—calculating a self-similarity feature vector representation that is indicative of similarities (of the RMI patch representation of a training image) with all other RMI patch representations related to the training image.
b. Calculating statistics per location—for example calculating a mean value and calculating a standard deviation.
   i. Calculate per location—a mean feature vector representation for all RMI patch representations located at the same location—across all the set of training images.
   ii. Calculate per location—a standard deviation feature vector representation for all RMI patch representations located at the same location—across all the set of training images.

An example of an implementation of method 200 is provided below.

A dataset with n training images is first split into m equally sized patches per image. A feature vector representation is produced for each patch. The similarity scores of each feature vector with each other feature vector is computed. The average and standard deviation of the relationships for the training set is obtained. An inference/test image is split into m equally sized patches per image. A feature vector representation is produced for each patch. The similarity of each feature vector with each other vector is computed. The relationship of each feature vector with the other feature vectors is compared with the average relationships obtained from the training images.

Pseudo-code—training:
1. For m=126 patches, n=200 training images
2. Split image j into 126 equal sizes patches.
3. Compute self-similarity of feature vector representation of patch i with all patches (yields a 1×126 vector of similarities), F_{i,j}.
4. Repeat for next patch i+1 with all other patches.
5. Repeat for next image, j+1.
6. Calculate mean feature vector representation for each patch across all 200 images:

$$\vert {F}_{i} \vert = \frac{1}{200} {\sum }_{j}^{200} {F}_{i , j} ,$$

repeated for all i.
7. Calculate standard deviation feature vector representation for each patch across all 200 images:

$${S}_{i} = \sqrt{\frac{{\sum }^{200} {( {F}_{i , j} - \vert {F}_{i} \vert )}^{2}}{200}} ,$$

repeated for all i.
8. Output—a 126×126 matrix of average similarities, and a 126×126 matrix of standard deviations of similarities.

In the mentioned above example, an example of implementing method 100 may be represented by the following pseudo-code:
1. Split a received image j into 126 equal sizes patches.
2. Compute self-similarity of feature vector representation of patch i with all patches (yields a 1×126 vector of similarities), Iᵢ.
3. Repeat (2) for next patch i+1 with all other patches.
4. Compute z-score for each Iᵢ with

$$\vert {F}_{i} \vert : {z}_{i} = \frac{{I}_{i} - {F}_{i}}{{S}_{i}} .$$

This results in a 126-length vector of z-scores for each patch.
5. The elements of the vector are then summed and the result is divided by 126 to get the average z-scores for each patch:

$$\vert {z}_{i} \vert = \frac{1}{126} {\sum }^{126} {z}_{i} .$$

6. A defect is signaled when the average z-score for a patch is significantly greater than a predefined value.

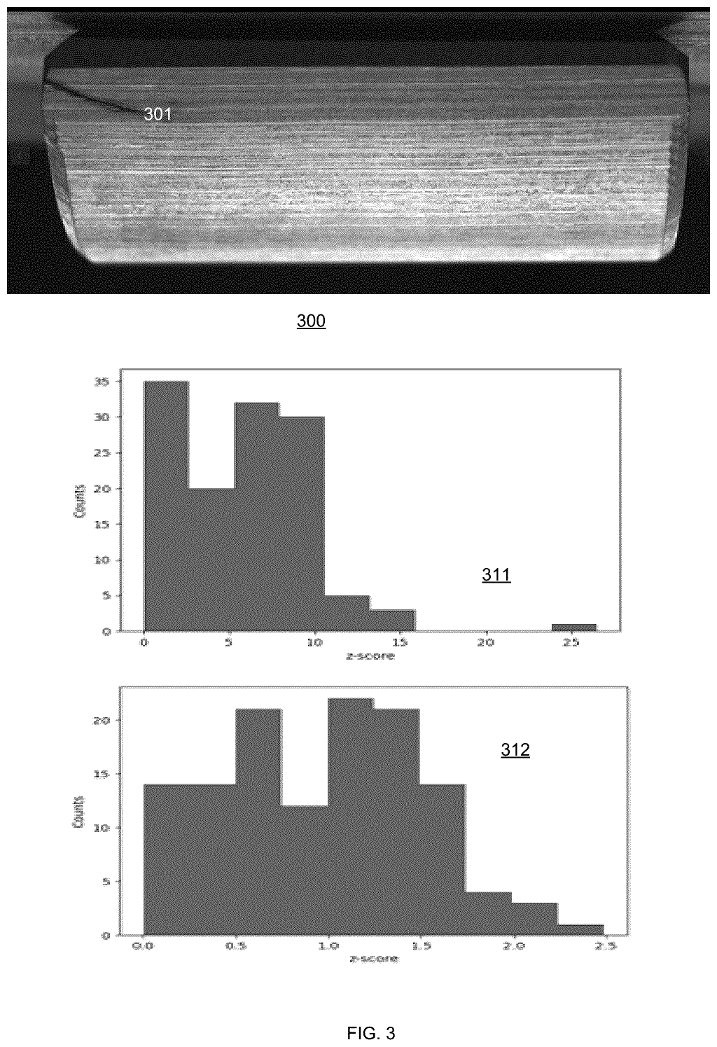

FIG. 3 is an example of an EMI 300 that has a defect 301 at its top left—at patch 19.

The z-score of patch 19 with all other patches is plotted in histogram 311 of FIG. 3.

An ordinary distribution 312 of the z-score without defect is plotted in histogram 312 of figure.

As can be seen from the shift in distributions, the relationship of patch 19 with the other patches significantly deviates from the mean (up to 25 standard deviations) relative to a non-defected patch. The average z-score is 5.96 (whereas for an ordinary patch, the average z-score is 0.96):

$$\vert {z}_{i} \vert = \frac{1}{126} {\sum }^{126} {z}_{i} = 5.96$$

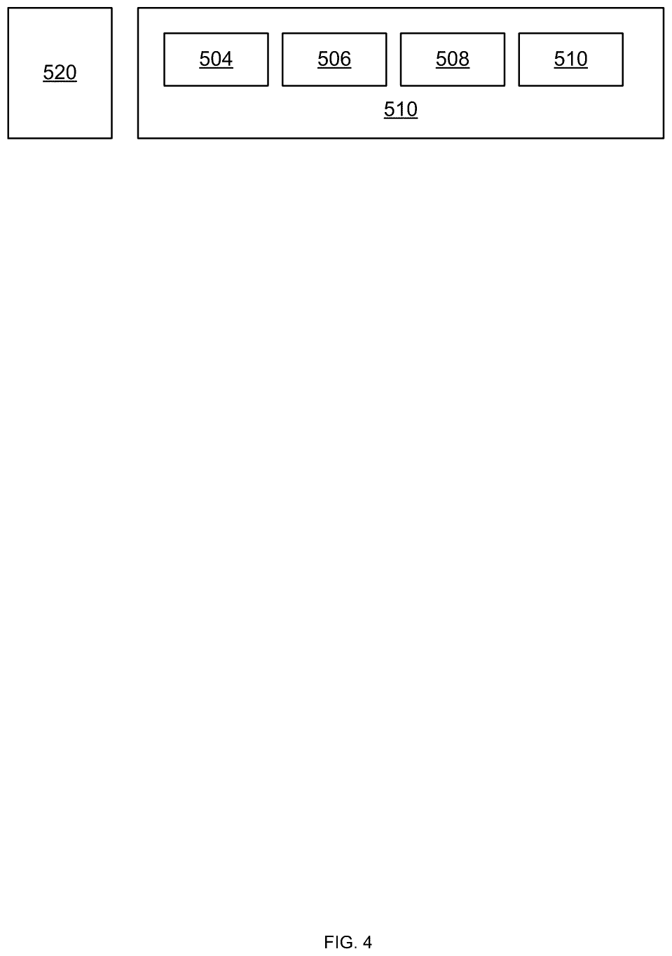

FIG. 4 illustrates an example of a computerized system 500 and a manufacturing process tool 520.

The computerized system 500 may execute method 100 and/or method 200.

The computerized system 500 may or may not communicate with the manufacturing process tool 520—for example to provide feedback about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include a communication unit 504, memory 506, processor 508 and may optionally include a man machine interface 510.

Another example of inference is illustrated below: An inference image is split into m equally sized patches per image. A feature vector representation is produced for each patch. The similarity of each feature vector with each other vector is computed and compared to a user-defined absolute threshold.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for context based detection of defects of manufactured items, the method comprises:
receiving an image of an evaluated manufactured item (EMI), the EMI was manufactured by a manufacturing process;
generating EMI patches representations that are related to the EMI; wherein the EMI patches representations of the EMI are selected out of (a) representations of patches of the image of the EMI, or (b) patches of a representation of the image of the EMI;
calculating EMI patches representations scores, wherein an EMI patch representation score of a certain EMI patch representation is determined based on similarities between the certain EMI patch representation and other EMI patch representations; and
determining a defect related status of the EMI based on at least some of the EMI patches representations scores and on at least one similarity related values.

2. The method according to claim 1, wherein the at least one similarity related value is at least one similarity threshold.

3. The method according to claim 1, wherein the at least one similarity related value is determined based on EMI patches representations scores learnt during a training process.

4. The method according to claim 1, wherein the at least one similarity related value is determined based on statistics of EMI patches representations scores learnt during a training process.

5. The method according to claim 1, wherein the at least one similarity related value is determined based on (a) a standard deviation of EMI patches representations scores learnt during a training process, and (b) a mean of EMI patches representations scores learnt during the training process.

6. The method according to claim 1, wherein the other EMI patch representations are all EMI patch representations other than the certain EMI patch representation.

7. The method according to claim 1, wherein the other EMI patch representations are only some of all EMI patch representations other than the certain EMI patch representation.

8. The method according to claim 1, wherein the other EMI patch representations are only neighbors of the certain EMI patch representation.

9. The method according to claim 1, wherein the determining comprises determining that two EMI patches representations are not indicative of a EMI defect when EMI patches representations scores if the two or more EMI patches representations are similar to each other.

10. The method according to claim 1, wherein the at least some of the EMI patches representations scores are all the EMI patches representations scores.

11. A non-transitory computer readable medium for context based detection of defects of manufactured items, the non-transitory computer readable medium stores instructions that once executed by a processor causes the processor to:
receive an image of an evaluated manufactured item (EMI), the EMI was manufactured by a manufacturing process;
generate EMI patches representations that are related to the EMI; wherein the EMI patches representations of the EMI are selected out of (a) representations of patches of the image of the EMI, or (b) patches of a representation of the image of the EMI;
calculate EMI patches representations scores, wherein an EMI patch representation score of a certain EMI patch representation is determined based on similarities between the certain EMI patch representation and other EMI patch representations; and
determine a defect related status of the EMI based on at least some of the EMI patches representations scores and on at least one similarity related values.

12. The non-transitory computer readable medium according to claim 11, wherein the at least one similarity related value is at least one similarity threshold.

13. The non-transitory computer readable medium according to claim 11, wherein the at least one similarity related value is determined based on EMI patches representations scores learnt during a training process.

14. The non-transitory computer readable medium according to claim 11, wherein the at least one similarity related value is determined based on statistics of EMI patches representations scores learnt during a training process.

15. The non-transitory computer readable medium according to claim 11, wherein the at least one similarity related value is determined based on (a) a standard deviation of EMI patches representations scores learnt during a training process, and (b) a mean of EMI patches representations scores learnt during the training process.

16. The non-transitory computer readable medium according to claim 11, wherein the other EMI patch representations are all EMI patch representations other than the certain EMI patch representation.

17. The non-transitory computer readable medium according to claim 11, wherein the other EMI patch representations are only some of all EMI patch representations other than the certain EMI patch representation.

18. The non-transitory computer readable medium according to claim 11, wherein the other EMI patch representations are only neighbors of the certain EMI patch representation.

19. The non-transitory computer readable medium according to claim 11, wherein the determining comprises determining that two EMI patches representations are not indicative of a EMI defect when EMI patches representations scores if the two or more EMI patches representations are similar to each other.

20. The non-transitory computer readable medium according to claim 11, wherein the at least some of the EMI patches representations scores are all the EMI patches representations scores.
